(19) United States
(12) Patent Application Publication
(10) Pub. No.: US 2015/0004935 A1
(43) Pub. Date: Jan. 1, 2015

(54) METHOD AND APPARATUS FOR GENERATING ACCESS CODES BASED ON INFORMATION EMBEDDED IN VARIOUS SIGNALS

(71) Applicant: Nokia Corporation, Espoo (FI)

(72) Inventor: Yan Fu, Espoo (FI)

(21) Appl. No.: 13/927,575

(22) Filed: Jun. 26, 2013

(51) Int. Cl. H04W 12/08; H04W 4/02

(52) U.S. Cl. CPC H04W 12/08; H04W 4/02
USPC 455/411

(57) ABSTRACT

An approach is provided for a mechanism to generate access codes based on information embedded in various signals available in an environment. The approach includes a method causing an acquisition of one or more signals broadcasted within an environment. The method also includes processing and/or facilitating a processing of the one or more signals to determine at least one access code seed associated with one or more location-based services available in the environment. The method further includes causing a generation of at least one access code for accessing the one or more location-based services based, at least in part, on the at least one access code seed.

### BACKGROUND

Service providers (e.g., wireless, cellular, etc.) and device manufacturers are continually challenged to deliver value and convenience to consumers by, for example, providing compelling network services. One area of interest is providing location-based services to users and user devices, for example, shared network communication services, while the users are at certain locations. In one scenario, a merchant (a service provider) may wish to provide access to a wireless communication network (e.g., a wireless local area network (WLAN)) for use by its patrons (users), as an incentive, so that the users may stay at or near the merchant's establishment (e.g., a coffee shop) or that the users would visit again, whereby the merchant may setup the network to require a security password/credential and then he would provide the password/credential to the users (e.g., when the users come to the counter, place a sign in the store, etc.) In many cases, a merchant may wish to avoid requiring and managing security passwords by providing an open-access network with better user experience and convenience for the users and the merchant. However, coverage of a wireless communication network may extend beyond a physical area that the merchant may have intended or wished to provide the services at, and once users obtain a password to the network, they can still access the network beyond the intended area (e.g., at another nearby shop). Therefore, service providers and device manufacturers face significant challenges in providing a more transparent and user friendly access control mechanism for location-based services.

### SOME EXAMPLE EMBODIMENTS

Therefore, there is a need for a mechanism to generate access codes based on information embedded in various signals.

According to one embodiment, a method comprises causing, at least in part, an acquisition of one or more signals broadcasted within an environment. The method also comprises processing and/or facilitating a processing of the one or more signals to determine at least one access code seed associated with one or more location-based services available in the environment. The method further comprises causing, at least in part, a generation of at least one access code for accessing the one or more location-based services based, at least in part, on the at least one access code seed.

According to another embodiment, an apparatus comprises at least one processor, and at least one memory including computer program code, the at least one memory and the computer program code configured to, with the at least one processor, cause, at least in part, the apparatus to cause, at least in part, an acquisition of one or more signals broadcasted within an environment. The apparatus is also caused to process and/or facilitate a processing of the one or more signals to determine at least one access code seed associated with one or more location-based services available in the environment. The apparatus is also caused to cause, at least in part, a generation of at least one access code for accessing the one or more location-based services based, at least in part, on the at least one access code seed.

According to another embodiment, a computer-readable storage medium carries one or more sequences of one or more instructions which, when executed by one or more processors, cause, at least in part, an apparatus to cause, at least in part, an acquisition of one or more signals broadcasted within an environment. The apparatus is also caused to process and/or facilitate a processing of the one or more signals to determine at least one access code seed associated with one or more location-based services available in the environment. The apparatus is also caused to cause, at least in part, a generation of at least one access code for accessing the one or more location-based services based, at least in part, on the at least one access code seed.

According to another embodiment, an apparatus comprises means for causing, at least in part, an acquisition of one or more signals broadcasted within an environment. The apparatus also comprises means for processing and/or facilitating a processing of the one or more signals to determine at least one access code seed associated with one or more location-based services available in the environment. The apparatus further comprises means for causing, at least in part, a generation of at least one access code for accessing the one or more location-based services based, at least in part, on the at least one access code seed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing for a mechanism to generate access codes based on information embedded in various signals, according to an embodiment;

FIG. 2 is a diagram of the components of a user equipment capable of generating access codes based on information embedded in various signals, according to an embodiment;

FIGS. 3-5 illustrate flowcharts of various processes for, at least, generating access codes based on information embedded in various signals, according to various embodiments;

FIG. 6 illustrates example user interface on a user device for accessing location-based services, according to an embodiments;

FIG. 7 illustrates a coverage area for a location-based, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for a mechanism to generate access codes based on information embedded in various signals. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

In general, different wireless signals have different characteristics, for example, some signals propagate farther and through various objects and structures with less degradation in signal quality, power, and integrity of information embedded in the signals. For example, audio and optical signals broadcasted in a spatial area may be isolated and best captured in the spatial area, whereas a wireless signal transmitted by a device for a wireless communication access network may propagate and penetrate through objects, structures, walls, doors, etc. in the same spatial area as the audio/optical signals. In the following discussion, references to a spatial area, environment, room, area, establishment, store, and the like, generally refer to a physical space where various wireless signals may be broadcasted. For example, in a coffee shop, there may be one or more signals broadcasted for a wireless communication network, audio signals via loudspeakers for playing music, optical/light signals, or other signals which may be used for various utilities in the coffee shop. Further, the spatial area may be an open area associated with a particular service provider (e.g., a merchant) where the one or more signals may be broadcasted; for example, an open area café broadcasting a wireless communication network signal and audio for playback music.

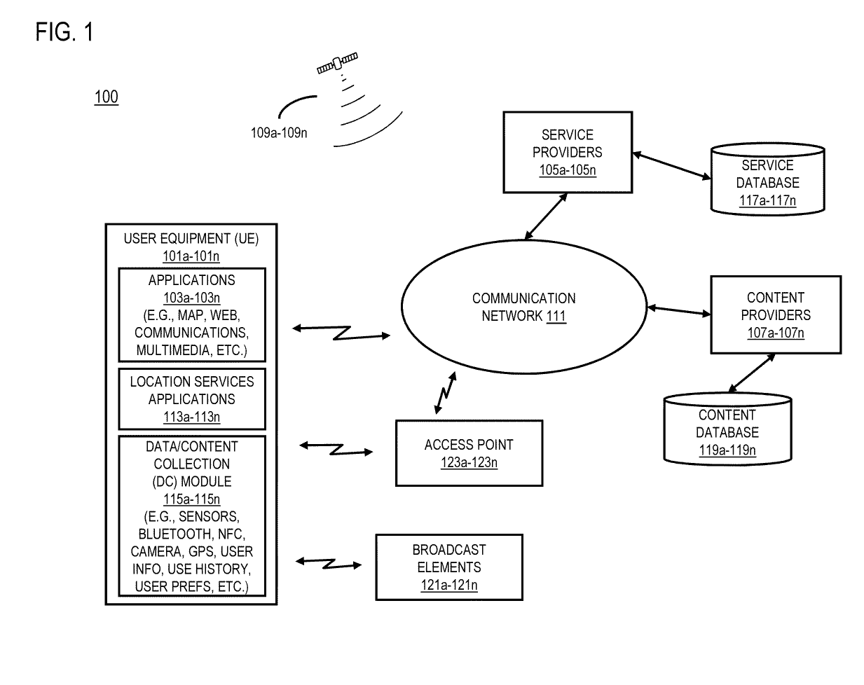

FIG. 1 is a diagram of a system capable of providing for a mechanism to generate access codes based on information embedded in various signals, according to an embodiment. As utilization of mobile devices has vastly proliferated in the recent years, user demand for access to various anytime/anywhere location-based services for the mobile devices has been increasing as well. For example, users often seek for connectivity to various communication networks (e.g., WLAN, cellular network, etc.) for accessing various online/Internet services and contents at various locations. As an incentive, a customer service, and marketing efforts, many service providers and merchants have been accommodating the user demand by providing such services at various points-of-interest (POI) locations. For example, many merchants provide free access to their, WLANs at their establishments, for their customers' (users) use. Additionally, the merchants may use the WLAN to present various information (e.g., coupons/offers) to users already near/at their business location/POI. In some settings, the merchants may set up an open access to the WLAN to provide ease of access and a good user-experience for the users as well as alleviate the issue of password management for the merchant. However, at times, a merchant may wish to restrict access to its WLAN to only those customers/users who may be within a certain area of a location/POI associated with the merchant so, for example, to encourage them to stay near or at the POI (e.g., a store, a restaurant, a coffee shop, etc.) location. However, as wireless signals propagate through different surfaces/materials, it would be challenging to limit the coverage area of a wireless network service to a desired physical area, wherein other users outside of the desired area may also access and utilize the service thereby causing additional loading/traffic on the network. Therefore, there is a need for a mechanism for the service providers/merchants to easily provide certain information that the users may utilize to determine and/or generate access codes/passwords to a location-based service.

To address, at least these problems, a system 100 of FIG. 1 introduces the capability of a mechanism to generate access codes based on information embedded in various signals. As discussed, in certain situations, a service provider may require a proof of presence of a user/device at a certain location/area associated with the service provider before allowing access to a service available at that location. However, at times, general location information (e.g., GPS, cellular network location information, etc.) may not be available (e.g., in a mall) or may not be sufficiently granular to prove presence of a user/device at an intended area. For instance, a user may acquire a password to a WLAN available at a store (e.g., a coffee shop) and then go outside of the store, but as wireless coverage area may go beyond the store, the user may still have access to the wireless service. Although wireless signals of a WLAN may travel through walls, ceilings, doors, etc., other signals such as audio and light/optical signals may not be as penetrating and may be better contained to a certain area, and even in an open area, sound/audio or light/optical signals degrade quicker than wireless radio frequency signals. Further, known audio and optical technologies, for example watermarking, have characteristic features that allow for embedding data into those signals with no human-perceivable differences; however, a device equipped with proper sensors and applications, can detect, decode, and determine the embedded information. In one scenario, a merchant may utilize one or more signals available at a POI to deliver/broadcast one or more information items to the user devices, where the user devices may utilize the information items to determine security and access codes associated with the WLAN. In one scenario, an audio signal may include music playing in the background at a POI (e.g., in a coffee shop, in a shopping mall, in an elevator, etc.) In another example, an optical signal may include a light source (e.g., a light bulb, a light emitting diode, overhead lights, etc.) at a POI. This approach would enhance user experience for accessing a wireless system without cumbersome input of passwords, no search for the passwords, no movements inside an area to prove presence, etc.

In one embodiment, one or more access code seeds may be embedded in and broadcast via one or more audio and/or optical signals. In one scenario, the access code seeds may be broadcast only in areas where an intended service is to be available, and a user device located in the area of interest may detect the audio/optical signals and decode the embedded information. For example, analog audio/optical signals may be captured, sampled, and processed by use of one or more digital signal processing schemes in a user device. In one scenario, a merchant may utilize a point of access network element for embedding an access code seed into one or more audio/optical signals. In one example, a WLAN point of access device/client may interface with the network element (e.g., a signal modulator) for embedding and managing the access code seed into the audio/optical signals. In one example, a WLAN point of access device may include required elements and/or clients for embedding, into the audio/optical signals, the access code seed and/or other information items associated with the WLAN service, with one or more other services, with the merchant, or the like.

In one use case scenario, a user with a mobile device may enter a store where the device may detect one or more audio or optical signals, decode embedded information associated with a wireless service available in the store, generate and transmit an access code to a point of access device for authentication. In such a scenario, there is no user action required for authentication and access to the wireless service, which would be a positive user experience; further, there is added value for the merchant for not having to actively manage passwords and access to his wireless network.

In one scenario, an access point (e.g., of a WLAN) may detect a mobile device within its range and transmit message to the mobile device for initiating and executing an application automatically, which may activate a microphone, a light sensor, a camera, etc. for detecting and decoding information embedded in the audio and/or optical signals. Further, the mobile device may generate and transmit an access code to the WLAN for authentication and access. In one example, a device may store and reuse geographical location information of POIs where the described mechanism may be utilized.

In various embodiments, a service provider may utilize capabilities and benefits of the system 100 to easily manage access control to various location-based services, and users/devices may utilize the capabilities and benefits of the system 100 to determine information embedded in various signals and generate authentication codes for accessing the various location-based services.

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as applications 103) including social networking, web browser, communications, content sharing, multimedia applications, user interface (UI), map application, web client, etc. to communicate with other UEs 101, one or more service providers 105a-105n (also collectively referred to as service providers 105), one or more content providers 107a-107n (also collectively referred to as content providers 107), one or more GPS satellites 109a-109n (also collectively referred to as GPS satellites 109), one or more broadcast elements 121a-121n (also collectively referred to as broadcast element 121), one or more access points 123a-123n, and/or with other components of the system 100 directly and/or via communication network 111. In one embodiment, the UEs 101 may include location services applications 113a-113n (also collectively referred to as location services application/applications 113.) In various embodiments, the location services application 113 may be included in the applications 103 or may be a stand-alone application.

In one embodiment, the UEs 101 may include data/content collection modules 115a-115n (also collectively referred to as DC module 115) for determining and/or collecting data and/or content associated with the UEs 101, one or more users of the UEs 101, applications 103, one or more content items (e.g., multimedia content), and the like. In addition, the UEs 101 can execute an application 103 that is a software client for storing, processing, and/or forwarding one or more information items to other components of the system 100. In various embodiments, the DC module 115 may include various sensors for detecting various signals, for example, audio, optical, Bluetooth, near field communication (NFC), RFID, or the like. In one embodiment, an audio or optical sensor (e.g., a microphone, a camera, etc.) on the UE 101 may be utilized to capture audio or optical/light signals for processing by one or more applications and/or modules at the UE 101, wherein the signals may include embedded/encoded information associated with a POI, an access code seed, a location-based service, a service provider, a procedure for accessing a service, and the like. In one embodiment, the processing of the embedded information may cause one or more actions by the applications 103 and/or one or more modules at the UE 101. For example, based on information determined from a processing of the embedded information, the applications 103 may establish a communication channel with a local point of access device 123, an Internet site of a service provider, or the like.

In one embodiment, the location services application 113 may include various algorithms or software programs for processing various signals and embedded information items according to one or more procedures for generating one or more access codes, wherein the embedded information items may also be detected and/or decoded by one or more applications and/or modules at a UE 101. In various embodiments, the embedded information items and access code seeds may be determined by the DC module 115, the applications 103, various sensors at the UE 101, or the like. For example, a microphone or a light sensor may detect one or more signals (e.g., optical/light, audio, etc.) from one or more nearby sources (e.g., loud speakers, light bulbs, etc.) broadcast elements 121, wherein the signals may be processed by the location services application 113, the DC module 115, the applications 103, or the like. In one instance, an application and/or an algorithm may determine an access code seed for use in generating an access code to one or more services.

In one example, a plurality of determined embedded information items or access code seeds in a plurality of signals from a plurality of broadcast elements in a given space (e.g., in a room) may be utilized to determine one or more access codes and/or location of a user/device in the given space, where the location information may be utilized as proof/indicator that the user/device is located in the room. In one embodiment, the location services application 113 may receive a procedure for decoding the embedded information items from the applications 103 and/or from one or more modules at the UE 101. In one embodiment, the location services application 113 may determine a procedure via one or more messages/notifications (e.g., short message service (SMS), email, etc.), which may be requested and/or received from a POI services, navigation services, search engines, or other service providers. In various embodiments, a location services application 113 may be specific to one or more locations, regions, service providers, operating systems, device types, or the like. In one embodiment, a location services application 113 may be utilized by any UE 101 at any location for any services. In one embodiment, the location services application 113 may be preloaded onto a UE 101 by a service provider or a device manufacturer, or it may be downloaded by a user or an application at a UE 101. In various embodiments, the location services application 113 may directly communicate an access code to an access point 123 or may present the access code to the applications 103 and/or one or more modules at the UE 101 so that the code may be communicated to the access point 123.

In one embodiment, the service providers 105 may include and/or have access to one or more service databases 117a-117n (also collectively referred to as service database 117), which may include various user information, user profiles, user preferences, one or more profiles of one or more user devices (e.g., device configuration, sensors information, etc.), service providers 105 information, other service providers' information, and the like. In one embodiment, the service providers 105 may include one or more service providers offering one or more services, for example, online shopping, social networking services (e.g., blogging), content sharing, media upload, media download, media streaming, account management services, or a combination thereof. Further, the service providers 105 may conduct a search for content items, media items, information, coupons, and the like associated with one or more users, POIs, geo-locations, and the like.

In one embodiment, the content providers 107 may include and/or have access to one or more content databases 119a-119n (also collectively referred to as content database 119), which may store, include, and/or have access to various content items. For example, the content providers 107 may store content items (e.g., at the content database 119) provided by various users, various service providers, crowd-sourced content, and the like. Further, the service providers 105 and/or the content providers 107 may utilize one or more service application programming interfaces (APIs)/integrated interface, through which communication, media, content, and information (e.g., associated with users, applications, services, content, etc.) may be shared, accessed and/or processed.

In various embodiments, the broadcast element 121 may include one or more signal sources, which may be placed within a spatial area, for example, on the walls, floor, ceiling, and any structures in a room/space as applicable. For example, a signal source may include RF, light/optical, audio, or the like sources, which may be transmitting/presenting one or more signals including a default signal and/or one or more information items encoded into the signal. For example, audio of playback music may be provided via one or more loudspeakers available in a coffee shop. Also, the coffee shop may include various light sources, which may provide optical signals. In various embodiments, the broadcast elements 121 and/or their signal sources (e.g., an audio source, an optical source, etc.) may interface with the access point 123 where the access point 123 and/or one or more other elements of the system 100 may embed one or more information items in one or more signals broadcasted via the broadcast elements 121. In various scenarios, one or more portions of the embedded information items may be broadcasted via a plurality of signals, which may be via a plurality of broadcast elements 121. For example, one portion of an access code seed may be broadcasted via a loudspeaker and another portion of the access code seed may be broadcasted via a light source situated within the same environment as the loudspeaker.

In various embodiments, an access point 123 may include hardware, software, firmware, and the like that may be utilized by users to access a LAN/WLAN and initiate a network connection, for example, to the communication network 111. An access point 123 may include an authentication module, which may contain authentication access codes/keys for authenticating or authorizing the users requesting access to the network. An access point 123 may provide a wireless Internet protocol (IP) connectivity authentication between a UE 101 and a communication network. In one embodiment, an access point 123 may provide one or more procedures or access code seeds to a UE 101, which the UE 101 may utilize in generating one or more access codes. For example, the access point 123 may provide a procedure via a communication channel that does not require any authentication between a UE 101 and the access point 123 (e.g., an open channel). In one embodiment, the access point 123 may include one or more elements (e.g., hardware, software, algorithms, etc.) for embedding one or more information items into one or more audio, optical, and the like signals. In one embodiment, the access point 123 may interact with one or more other network elements for embedding the one or more information items into the one or more audio, optical, and the like signals.

In one embodiment, the applications 103 and/or the location services application 113 may analyze the name or identification information associated with an available wireless service at a certain location to determine whether the location services application 113 and/or the DC module 115 should initiate detection, capturing, and processing of available audio, optical, or other signals at that certain location in order to access the available wireless service. In one scenario, a user with his user device may enter a store where there is a wireless service available where the applications 103 and/or the location services application 113 may quickly scan and analyze the name or identification information of the wireless service to determine if there is any access information associated with the name or identification information. For example, if the identification information includes “Guest” and no other access information, then it may indicate to the location services application 113 that there may not be enough information for an automatic access to the “Guest” wireless service. However, in one example, the identification information may include “Guest (automatic and secure access),” which may indicate to the location services application 113 may initiate various procedures for detection, capturing, and processing of available audio, optical, or other signals at the certain location in order to access the available wireless service. The user device may be able to save power and processing resources by initiating the processes at the location services application 113 only when it is possible to determine information for a substantially automatic access to a location-based service.

In one embodiment, the system 100 causes, at least in part, an acquisition of one or more signals broadcasted within an environment. In various embodiments, the one or more signals include an audio signal, an optical signal, or a combination thereof. In one embodiment, a location services application 113 on a UE 101 may acquire one or more audio, optical, or the like signals from one or more sources associated with at least one geographical boundary/environment associated with at least one location, at least one service, or a combination thereof. For example, the signals may be detected or captured by the DC module 115 and may be processed and/or utilized by the applications 103 and/or the location services application 113. In one embodiment, the one or more audio/optical signals may be broadcast from one or more broadcast elements 121, for example, the signals may be broadcast via one or more loud speakers, one or more optical/light sources, or the like, which may be located at one or more locations in a given room, area, compartment, zone, and the like.

In one embodiment, the system 100 processes and/or facilitates a processing of the one or more signals to determine at least one access code seed associated with one or more location-based services available in the environment. In one embodiment, DC module 115, the location services application 113, and/or the applications 103 may utilize one or more algorithms and/or decoding schemes to decode/decrypt the embedded information items and determine one or more access code seeds. The one or more information items and/or the one or more access code seeds may indicate additional information associated with available service and/or a service provider associated with the environment where the one or more signals are broadcasted. In one embodiment, the location services application 113 may determine a procedure via one or more messages/notifications (e.g., short message service (SMS), email, etc.) for detecting, decoding, or decrypting the embedded information items and/or access code seeds. In one embodiment, the system 100 may determine contextual information associated with an audio signal (e.g., what music is being played). In one embodiment, the system 100 may determine information associated with an optical signal, for example, color of a light associated with the optical signal, a frequency of the light signal, intensity of the optical signal, or the like.

In one embodiment, the system 100 causes, at least in part, a generation of at least one access code for accessing the one or more location-based services based, at least in part, on the at least one access code seed. In one embodiment, the location services application 113 may utilize one or more algorithms, software programs, or the like to process the access code seed, wherein the access code seed may include information/data associated with a service provider, an available service (e.g., a WLAN) identification information, location information, and the like. Further, the location services application 113 may determine one or more procedures and/or process steps for generating the one or more access codes. In one example, the embedded information and/or access code seeds may provide information as to how to generate the one or more access codes. In one embodiment, the generation of the at least one access code is based, at least in part, on one or more information items associated with a user, a user device, or a combination thereof. In one scenario, the location services application 113 may utilize one or more information items associated with the environment, the service provider, the type of service, information associated with the user or the user device, or the like in addition to the access code seed for generating one or more access codes. In one instance, the procedure may indicate that the access code seed should be added, subtracted, divided, multiplied, truncated, expanded, or the like operations by the one or more algorithms in certain order. In one embodiment, the system 100 determines one or more attributes associated with a user, a user device, or a combination thereof that is requesting an access to the at least one service. In one embodiment, the location services application 113 may determine the one or more attributes and/or information items associated with a user and/or a user device and/or it may request/retrieve the attributes and/or the information from the applications 103 or one or more module at the UE 101. In various embodiments, the attributes may include a user history, user preferences, user device type, applications available at the user device, physiological information of the user, or the like. In one embodiment, the access code seed may be an access code by itself, which the location services application 113 may utilize as an access code. For example, one or more information items associated with an access code seed may indicate to the location services application 113 that the access code seed is an actual access code.

In one embodiment, the system 100 causes, at least in part, a transmission of the at least one access code to an access point client for accessing at least one of the one or more location-based services, wherein the at least one of the one or more location-based services is a wireless communication network service. In one example, a UE 101 may transmit an access code to the access point 123 for authentication and access to a wireless communication network service.

In one embodiment, the system 100 determines one or more location characteristics of a user device with reference to a point of interest associated with the environment. In one scenario, in addition to the access code or instead of the access code, the location services application 113 may determine and provide one or more characteristics associated with an environment where the user device may attempt to gain access to one or more services may be available. For example, the access point 123 may present a message to the user of the user device to point the device toward a nearby loud speaker so that the device may determine one or more characteristics (e.g., volume, angle, etc.) associated with an audio signal being streamed via the loud speaker. In another example, the device may be requested to determine one or more characteristics associated with an optical signal available in the environment, for instance, a blinking light, intensity of the light, color of the light, and the like. In one embodiment, the access point 123 may transmit or cause a presentation of one or more information items associated with the service provider/merchant, for example, coupons, advertisement, a message specific to a user, and the like based on the location and/or characteristics reported by the device.

In one embodiment, the system 100 causes, at least in part, a transmission of the one or more location characteristics to the access point client for accessing at least one of the one or more location-based services. In one example, the location services application 113 may determine one or more location characteristic information items and transmit the information to the access point 123 for authentication that the user device is within the intended environment so that the access point 123 may grant access to one or more available services (WLAN) within the environment (e.g., a coffee shop).

In one embodiment, the system 100 determines a change in the at least one access code seed. In one scenario, the access point 123 may cause a change to one or more access code seeds, which may be associated with various services available in the environment associated with the access point 123. For example, a merchant may wish to change access codes to a WLAN service available at his establishment so that potential abuse of a past known password may be avoided/reduced. In one embodiment, the access code seed may indicate a time when the access code seed was last changed so that a user device may be able to determine if it needs to recalculate a current access code.

In one embodiment, the system 100 causes, at least in part, an update to the at least one access code based, at least in part, on the change in the at least one access code seed. In one embodiment, an access code may be updated before a current access code expires, which may allow a currently utilized service to continue without any significant interruption to the service. In one embodiment, the location services application 113 may cause a generation of a new access code based on the new access code seed and a transmission of the new access code to the access point 123. In one embodiment, the generation of a new access code may include use of one or more other location characteristic information determined at the time of the generation of the new access code.

In one embodiment, the system 100 causes, at least in part, a termination of an access to at least one of the one or more location-based services based, at least in part, on a discontinued acquisition of the one or more signals. In one scenario, an access and/or a continued access to a service by a user device at a certain POI may depend on the user device being able to periodically or continuously detect and acquire one or more audio/optical signals at the POI. In one embodiment, the access point 123 and/or the location services application 113 may terminate an access to a service if the user device is not able to detect and acquire the one or more signals within a given window of time. For example, the access point 123 may request for a user device to acquire a sample of an audio signal and transmit it to the access point 123 and/or one or more other network elements for verification that the user device most likely is located within a certain POI location. In one embodiment, if the user device is not able to correctly acquire and report the audio sample within a predetermined window of time, then the access point 123 may terminate the access of the user device to one or more services at the POI location. In one embodiment, the location services application 113 may cause the termination of the access to the service.

In one embodiment, the system 100 determines one or more information items associated with the environment, a service provider associated with the environment, or a combination thereof for decrypting at least one encrypted access code seed. In one scenario, the access point 123 may request for user device to determine one or more information items associated with a POI location (e.g., a coffee shop) and/or a service provider (e.g., a merchant) associated with the POI location so that the user device may utilize the information items in decrypting/decoding and encrypted/encoded access code seed embedded in one or more signals associated with the POI location. For example, the access point 123 may request for the user device to use information in an electronic coupon which is broadcasted in a store. In one example, a user may be requested to input one or more information items, which may be displayed within the environment where one or more location-based services may be available, for instance, the user may be asked to input the name of an item that may be displayed as “daily special” on a menu posted inside the store.

In one embodiment, the system 100 causes, at least in part, an initiation of the processing of the one or more signals based, at least in part, on a transaction with a device associated with the service provider, a capture, at the user device, of a media item associated with the environment, or a combination thereof. In one embodiment, the initiation is based, at least in part, on one or more trigger signals in the one or more signals. In one scenario, a user may be conducting a transaction (e.g. buy a sandwich) with a service provider at the service provider's establishment where one or more location-based services may be available (e.g., WLAN), which may require an access code. Further, a service provider device used to conduct the transaction may transfer/present one or more information items to the user device, which may cause the user device of the user to initiate a processing of one or more signals (e.g., audio, optical, etc.) at the establishment and determine one or more embedded access code seeds for generating an access code to access the one or more available location-based services. In various examples, the transaction and transfer of the information may be via NFC, Bluetooth, or the like. In one embodiment, the location services application 113 may utilize information associated with a prior visit at a POI location for determining any relevant information, which may be utilized for determining an access code seed and generating an access code. For example, the user may use his NFC enabled user device to pay for a purchase at a cash register, and the cash register and/or another service provider device (e.g., an NFC module connected to the cash register) may transfer an access code, an access code seed, or a key for decrypting an access code and/or an access code seed embedded in one or more audio, optical, and/or other signals broadcasted in the store.

Generally, the UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, loud speakers, display monitors, radio broadcast receiver, electronic book device, game device, wrist watch, or any combination thereof, including the accessories and peripherals of these devices, or any combination thereof. It is also contemplated that the UEs can support any type of interface to the user (such as “wearable” circuitry, etc.) Further, the UEs 101 may include various sensors for collecting data associated with a user, a user's environment, and/or with a UE 101, for example, the sensors may determine and/or capture audio, video, images, atmospheric conditions, device location, user mood, ambient lighting, user physiological information, device movement speed and direction, and the like.

In one embodiment, the UE 101 includes a location module/sensor that can determine the UE 101 location (e.g., a user's location). The UE 101 location may be determined by a triangulation system such as a GPS, assisted GPS (A-GPS), Cell of Origin, wireless local area network triangulation, or other location extrapolation technologies. Standard GPS and A-GPS systems can use the one or more satellites 109 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., LAN, WLAN) connection to determine the UE 101 location information, for example, from an Internet source (e.g., a service provider).

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UEs 101, the service providers 105, the content providers 107, and the access points 123 may communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the UEs 101, the service providers 105, and the access points 123 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is also noted that the role of a client and a server is not fixed; in some situations a device may act both as a client and a server, which may be done simultaneously and/or the device may alternate between these roles.

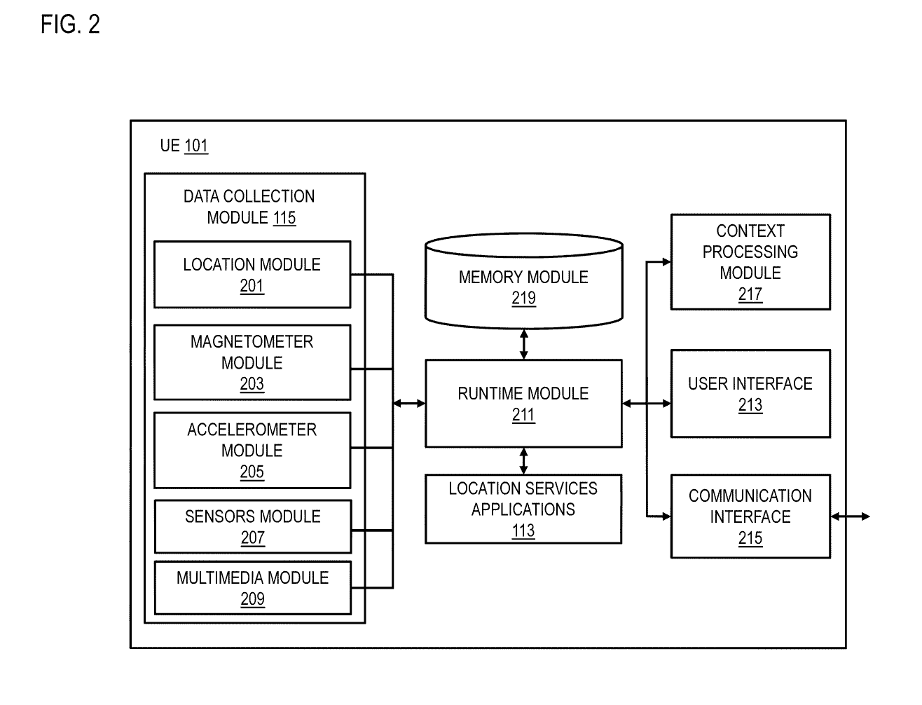

FIG. 2 is a diagram of the components of a user equipment capable of generating access codes based on information embedded in various signals, according to an embodiment. By way of example, a UE 101 includes one or more components for generating access codes based on information embedded in various signals. It is contemplated that the functions of these components may be combined in one or more components or performed by other components of equivalent functionality. In this embodiment, the UE 101 includes a DC module 115 that may include one or more location modules 201, magnetometer modules 203, accelerometer modules 205, sensors module 207, and multimedia module 209. Further, the UE 101 may also include a runtime module 211 to coordinate the use of other components of the UE 101, the location services application 113, a user interface 213, a communication interface 215, a context processing module 217, and a memory module 219. The applications 103 and location services application 113 of the UE 101 can execute on the runtime module 211 utilizing the components of the UE 101.

The location module 201 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 109 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory module 219 and are available to the context processing module 217, the DC module 115, the service providers 105, and/or to other entities of the system 100 (e.g., via the communication interface 215.) Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory module 219, made available to other modules and/or applications 103 of the UE 101, and/or transmitted via the communication interface 215 to one or more entities of the system 100.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory module 219, made available to other modules and/or applications 103 of the UE 101, and/or sent to one or more entities of the system 100.

In various embodiments, the sensors module 207 can process sensor data from various sensors (e.g., microphone, optical, Bluetooth, NFC, GPS, accelerometer, gyroscope, thermometer, etc.) to determine environmental (e.g., atmospheric) conditions surrounding the UE 101, user mood (e.g., hungry, angry, tired, etc.), location information, and various other information from a range sensors that may be available on one or more devices. For example, the sensors module 207 may detect conditions including humidity, temperature, geo-location, biometric data of the user, etc. Once again, this information can be stored in the memory module 219 and sent to the context processing module 217 and/or to other entities of the system 100. In certain embodiments, information collected from the DC collection module 115 can be retrieved by the runtime module 211 and stored in memory module 219, made available to other modules and/or applications 103 of the UE 101, and/or sent to one or more entities of the system 100. In one embodiment, the UE 101 may utilize a microphone to acquire audio signals available in a given environment, for example, detect and capture music being broadcasted via one or more speakers. In one embodiment, a camera or a light sensor may be utilized to detect light produced by various light sources, for example, light bulbs, light emitting diodes, or the like. In various embodiments, the runtime module 211 may utilize various processors (e.g., a digital signal processor) to process the audio and optical signals for detecting and decoding various data or information items embedded therein.

In one embodiment, the multimedia module 209 may be utilized to capture various media items, for example, images, video, audio, and the like, wherein the captured media may be submitted to one or more modules and applications of the UE 101, a service provider, and/or a content provider to further processing, storage, sharing, and the like. In various embodiments, the captured media may be shared with a content sharing module, application, etc. for sharing with one or more other devices. In various embodiments, the multimedia module 209 may interface with various sensors; for example, a camera, a microphone, etc., to capture the media items at a UE 101.

In one embodiment, the communication interface 215 can be used to communicate with one or more entities of the system 100. In various embodiments, the communication interface 215 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the communication network 111). In some examples, the UE 101 can send context information associated with the UE 101 to the service providers 105, content providers 107, and/or to other entities of the system 100.

The user interface 213 can include various methods for a user to interface with applications, modules, sensors, and the like at a UE 101. For example, the user interface 213 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

The context processing module 217 may be utilized in determining context information from the location services application 113, DC module 115 and/or applications 103 executing on the runtime module 211. This information may be caused to be transmitted, via the communication interface 215, to the service providers 105 and/or to other entities of the system 100. The context processing module 217 may additionally be utilized as a means for determining information related to the user, an instance of data, a value, a content item, an object, a subject, and the like. In certain embodiments, the context processing module 217 can infer higher level context information from the context data such as favorite locations, significant places, common activities, interests in products and services, POIs at various geo-locations, etc.

In various embodiments, the runtime module may cause one or more modules/components of a UE 101 to associate one or more available data items with one or more content items available from the one or more modules/components of the UE 101. For example, date, time, location, and user information associated with a device at a particular time may be associated (e.g., as metadata) with an image that is captured by the UE 101 at that particular time.

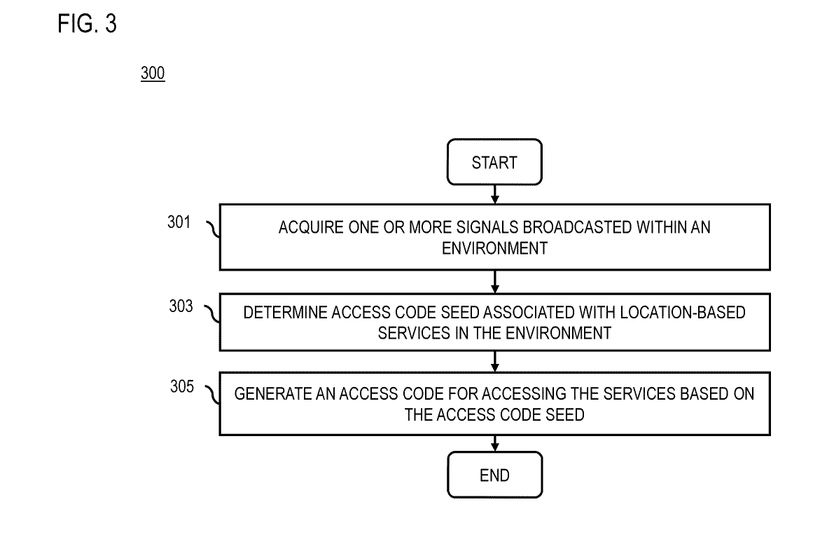

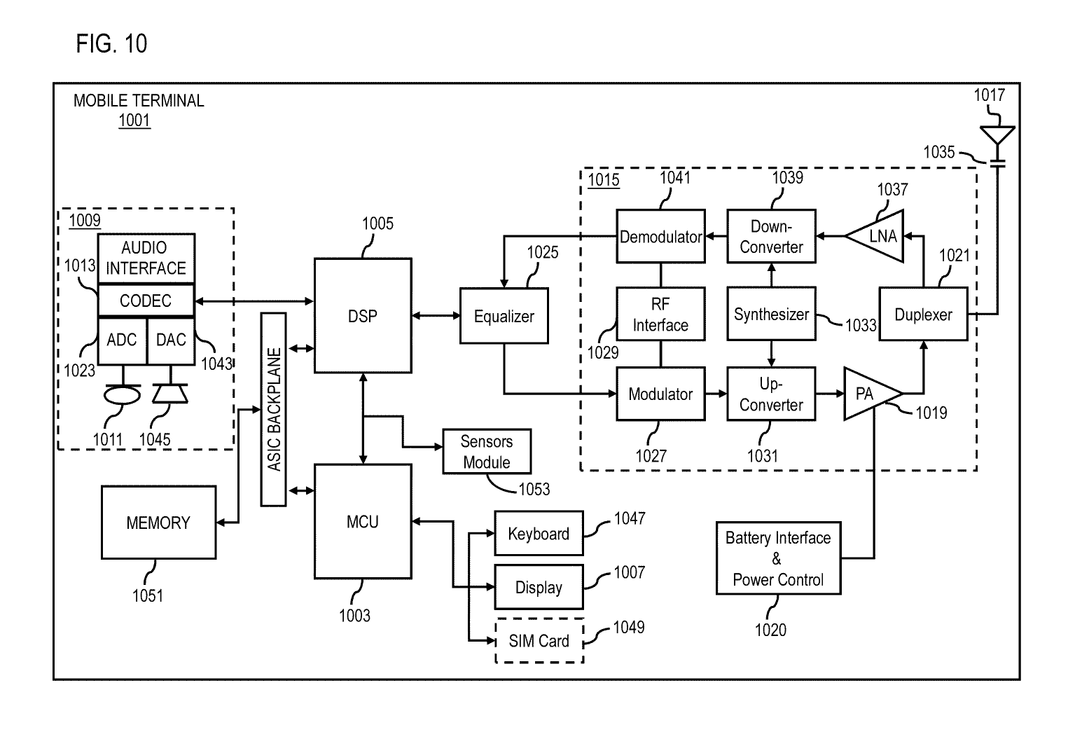

FIGS. 3 through 5 illustrate flowcharts of various processes for, at least, generating access codes based on information embedded in various signals, according to various embodiments. In various embodiments, the location services application 113 may perform processes 300, 400, and 500 that may be implemented, for instance, in a chip set including a processor and a memory as shown in FIG. 10. As such, the location services application 113 can provide means for accomplishing various parts of the process 300, 400, and 500 as well as means for accomplishing other processes in conjunction with other components of the system 100. Throughout this process, the location services application 113 may be referred to as completing various portions of the processes 300, 400, and 500, however, it is understood that other components of the system 100 can perform some of and/or all of the process steps. Further, in various embodiments, the location services application 113 may be implemented in one or more entities of the system 100.

Referring to FIG. 3, the process 300 begins at step 301 where the location services application 113 may cause, at least in part, an acquisition of one or more signals broadcasted within an environment. In various embodiments, the one or more signals include an audio signal, an optical signal, or a combination thereof. In one embodiment, a location services application 113 on a UE 101 may acquire one or more audio, optical, or the like signals from one or more sources associated with at least one geographical boundary/environment associated with at least one location, at least one service, or a combination thereof. For example, the signals may be detected or captured by the DC module 115 via one or more sensors at the UE 101 (e.g., microphone, camera, light sensor, etc.) and may be processed and/or utilized by the applications 103 and/or the location services application 113. In one embodiment, the one or more audio/optical signals may be broadcast from one or more broadcast elements 121, for example, the signals may be broadcast via one or more loud speakers, one or more optical/light sources, or the like, which may be located at one or more locations in a given room, area, compartment, zone, and the like.

In step 303, the location services application 113 may process and/or facilitate a processing of the one or more signals to determine at least one access code seed associated with one or more location-based services available in the environment. In one embodiment, DC module 115, the location services application 113, and/or the applications 103 may utilize one or more algorithms and/or decoding schemes to decode/decrypt the embedded information items and determine one or more access code seeds. The one or more information items and/or the one or more access code seeds may indicate additional information associated with available service and/or a service provider associated with the environment where the one or more signals are broadcasted. In one embodiment, the location services application 113 may determine a procedure via one or more messages/notifications (e.g., short message service (SMS), email, etc.) for detecting, decoding, or decrypting the embedded information items and/or access code seeds. In one embodiment, the system 100 may determine contextual information associated with an audio signal (e.g., what music is being played). In one embodiment, the system 100 may determine information associated with an optical signal, for example, color of a light associated with the optical signal, a frequency of the light signal, intensity of the optical signal, or the like.

In step 305, the location services application 113 may cause, at least in part, a generation of at least one access code for accessing the one or more location-based services based, at least in part, on the at least one access code seed. In one embodiment, the location services application 113 may utilize one or more algorithms, software programs, or the like to process the access code seed, wherein the access code seed may include information/data associated with a service provider, an available service (e.g., a WLAN) identification information, location information, and the like. Further, the location services application 113 may determine one or more procedures and/or process steps for generating the one or more access codes. In one example, the embedded information and/or access code seeds may provide information as to how to generate the one or more access codes. In one embodiment, the generation of the at least one access code is based, at least in part, on one or more information items associated with a user, a user device, or a combination thereof. In one scenario, the location services application 113 may utilize one or more information items associated with the environment, the service provider, the type of service, information associated with the user or the user device, or the like in addition to the access code seed for generating one or more access codes. In one instance, the procedure may indicate that the access code seed should be added, subtracted, divided, multiplied, truncated, expanded, or the like operations by the one or more algorithms in certain order. In one embodiment, the system 100 determines one or more attributes associated with a user, a user device, or a combination thereof that is requesting an access to the at least one service. In one embodiment, the location services application 113 may determine the one or more attributes and/or information items associated with a user and/or a user device and/or it may request/retrieve the attributes and/or the information from the applications 103 or one or more module at the UE 101. In various embodiments, the attributes may include a user history, user preferences, user device type, applications available at the user device, physiological information of the user, or the like.

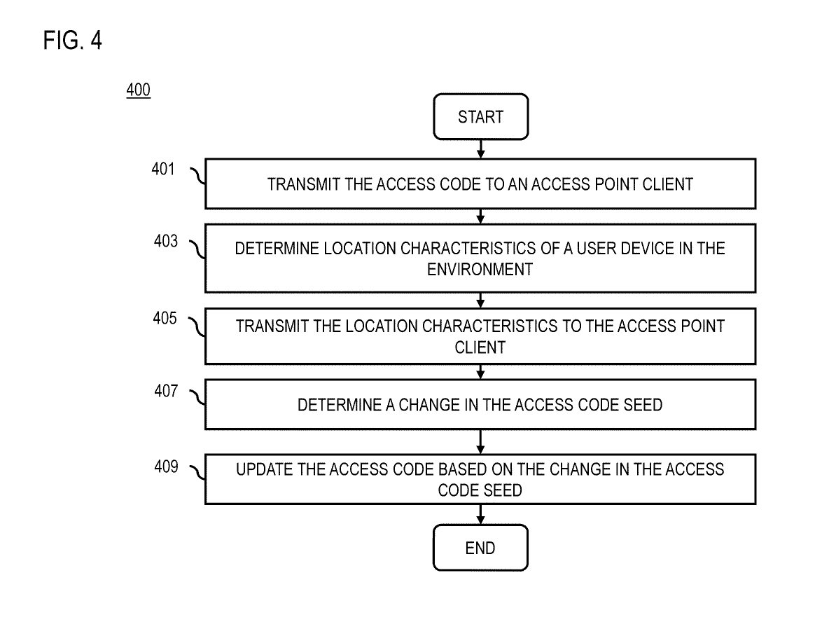

Referring to FIG. 4, the process 400 begins at step 401 where the location services application 113 may cause, at least in part, a transmission of the at least one access code to an access point client for accessing at least one of the one or more location-based services, wherein the at least one of the one or more location-based services is a wireless communication network service. In one example, a UE 101 may transmit an access code to the access point 123 for authentication and access to a wireless communication network service.

In step 403, the location services application 113 may determines one or more location characteristics of a user device with reference to a point of interest associated with the environment. In one scenario, in addition to the access code or instead of the access code, the location services application 113 may determine and provide one or more characteristics associated with an environment where the user device may attempt to gain access to one or more services may be available. For example, the access point 123 may present a message to the user of the user device to point the device toward a nearby loud speaker so that the device may determine one or more characteristics (e.g., volume, angle, etc.) associated with an audio signal being streamed via the loud speaker. In another example, the device may be requested to determine one or more characteristics associated with an optical signal available in the environment, for instance, a blinking light, intensity of the light, color of the light, and the like. In one embodiment, the access point 123 may transmit or cause a presentation of one or more information items associated with the service provider/merchant, for example, coupons, advertisement, a message specific to a user, and the like based on the location and/or characteristics reported by the device.

In step 405, the location services application 113 may cause, at least in part, a transmission of the one or more location characteristics to the access point client for accessing at least one of the one or more location-based services. In one example, the location services application 113 may determine one or more location characteristic information items and transmit the information to the access point 123 for authentication that the user device is within the intended environment so that the access point 123 may grant access to one or more available services (WLAN) within the environment (e.g., a coffee shop).

In step 407 the location services application 113 may determine a change in the at least one access code seed. In one scenario, the access point 123 may cause a change to one or more access code seeds, which may be associated with various services available in the environment associated with the access point 123. For example, a merchant may wish to change access codes to a WLAN service available at his establishment so that potential abuse of a past known password may be avoided/reduced. In one embodiment, the access code seed may indicate a date when the access code seed was last changed so that a user device may be able to determine if it needs to recalculate a current access code.

In step 409, the location services application 113 may cause, at least in part, an update to the at least one access code based, at least in part, on the change in the at least one access code seed. In one embodiment, an access code may be updated before a current access code expires, which may allow a currently utilized service to continue without any significant interruption to the service. In one embodiment, the location services application 113 may cause a generation of a new access code based on the new access code seed and a transmission of the new access code to the access point 123. In one embodiment, the generation of a new access code may include use of one or more other location characteristic information determined at the time of the generation of the new access code.

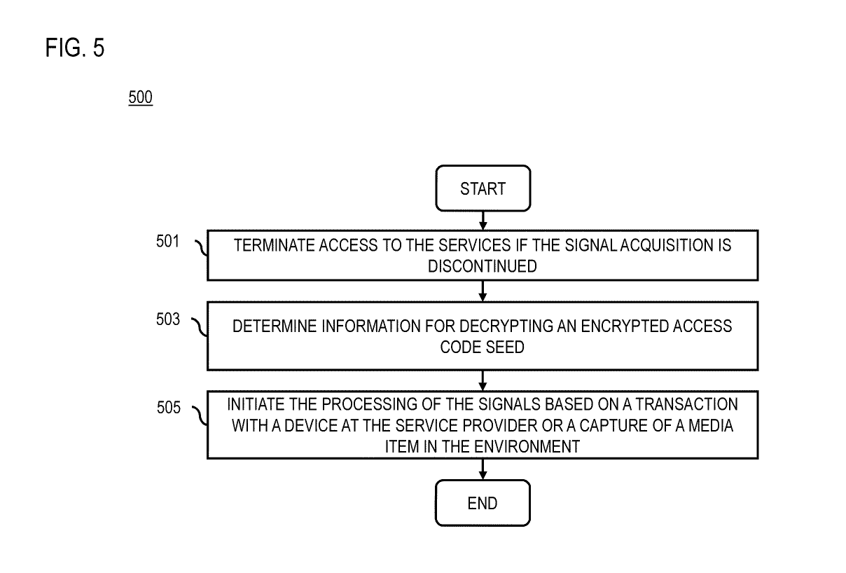

Referring to FIG. 5, the process 500 begins at step 501 where the location services application 113 cause, at least in part, a termination of an access to at least one of the one or more location-based services based, at least in part, on a discontinued acquisition of the one or more signals. In one scenario, an access and/or a continued access to a service by a user device at a certain POI may depend on the user device being able to periodically or continuously detect and acquire one or more audio/optical signals at the POI. In one embodiment, the access point 123 and/or the location services application 113 may terminate an access to a service if the user device is not able to detect and acquire the one or more signals within a given window of time. For example, the access point 123 may request for a user device to acquire a sample of an audio signal and transmit it to the access point 123 and/or one or more other network elements for verification that the user device most likely is located within a certain POI location. In one embodiment, if the user device is not able to correctly acquire and report the audio sample within a predetermined window of time, then the access point 123 may terminate the access of the user device to one or more services at the POI location. In one embodiment, the location services application 113 may cause the termination of the access to the service.

In step 503, the location services application 113 may determine one or more information items associated with the environment, a service provider associated with the environment, or a combination thereof for decrypting at least one encrypted access code seed. In one scenario, the access point 123 may request for user device to determine one or more information items associated with a POI location (e.g., a coffee shop) and/or a service provider (e.g., a merchant) associated with the POI location so that the user device may utilize the information items in decrypting/decoding and encrypted/encoded access code seed embedded in one or more signals associated with the POI location. For example, the access point 123 may request for the user device to use information in an electronic coupon which is broadcasted in a store. In one example, a user may be requested to input one or more information items, which may be displayed within the environment where one or more location-based services may be available, for instance, the user may be asked to input the name of an item that may be displayed as “daily special” on a menu posted inside the store.

In step 505, the location services application 113 may cause, at least in part, an initiation of the processing of the one or more signals based, at least in part, on a transaction with a device associated with the service provider, a capture, at the user device, of a media item associated with the environment, or a combination thereof. In one embodiment, the initiation is based, at least in part, on one or more trigger signals in the one or more signals. In one scenario, a user may be conducting a transaction (e.g. buy a sandwich) with a service provider at the service provider's establishment where one or more location-based services may be available (e.g., WLAN), which may require an access code. Further, a service provider device used to conduct the transaction may transfer/present one or more information items to the user device, which may cause the user device of the user to initiate a processing of one or more signals (e.g., audio, optical, etc.) at the establishment and determine one or more embedded access code seeds for generating an access code to access the one or more available location-based services. In various examples, the transaction and transfer of the information may be via NFC, Bluetooth, or the like. In one embodiment, the location services application 113 may utilize information associated with a prior visit at a POI location for determining any relevant information, which may be utilized for determining an access code seed and generating an access code.

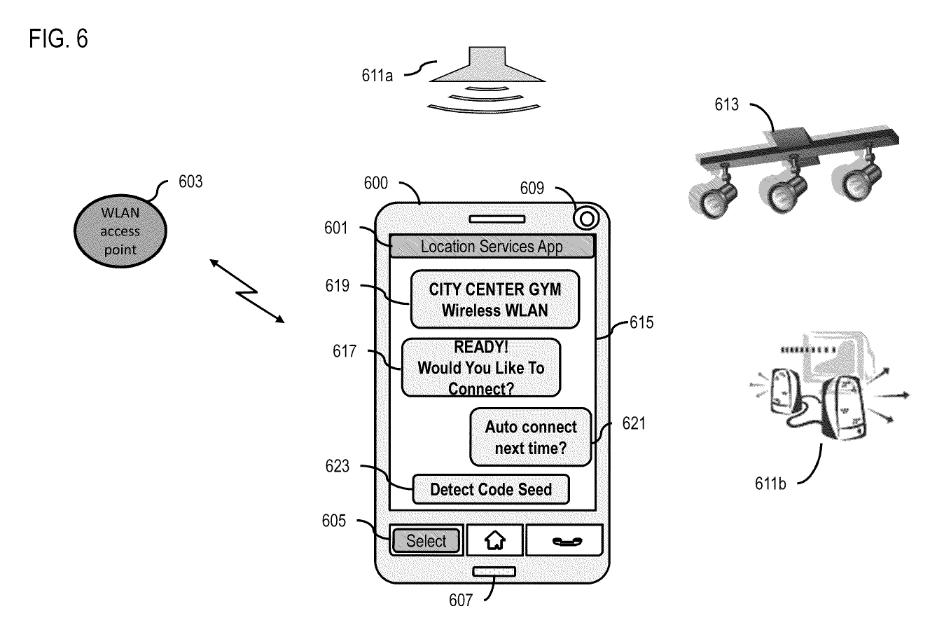

FIG. 6 illustrates example user interface on a user device for accessing location-based services, according to an embodiment. In one scenario, a user may utilize a location services application 601 on a user device 600 (e.g., UE 101) to discover one or more services, which may be available from one or more service providers, for example, a WLAN access point 603 made available by a merchant near a POI. In one example, the user may select different options from various UI features and options 605. In one use case scenario, a user may enter a physical environment (e.g., a gym) while carrying a user device where the user device may detect audio, via a microphone 607, and/or optical signals via a camera or light sensor 609 (e.g., broadcast elements 121); for example, music being played via loudspeakers, 611a-611b, or via various light sources 613 installed in the environment. In one example, a location services application may process the signals to determine if there is embedded information, which may be used to generate an access code for accessing one or more location-based services that may be available in the environment. In one embodiment, the user device may determine an embedded access code seed and then the utilize the access code seed to generate and transmit an access code to the access point 603 for authorization and access. Further, the user device may present to the user, via user interface 615, various information and options associated with one or more available services. In one scenario, the user device 600 may query, in 617, whether the user may wish to access the service 619, which an access code has been determined for, or if the user device 600 should auto connect, via option 621, to the service 619 during a future visit, and the like. In one embodiment, a user of the user device 600 may manually initiate a detection of an access code seed or information via a user interface option 623. In one embodiment, to reduce power consumption, the user may wish to manually launch the location services application 113 instead of it being active all the time.

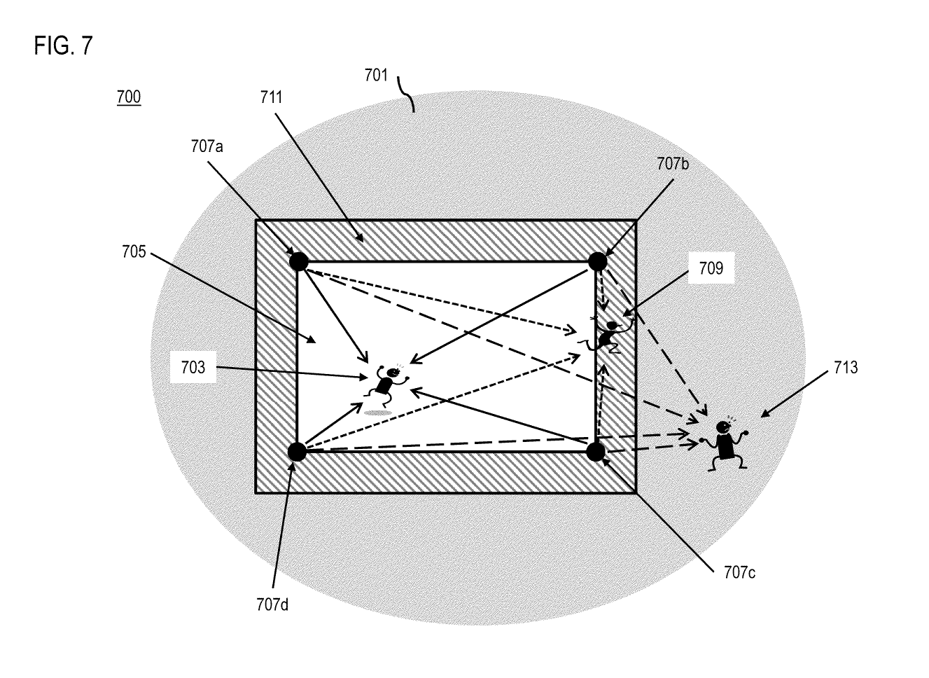

FIG. 7 illustrates a coverage area for a location-based service. In one use case scenario, a location-based service 700 may be associated with a service provider (e.g., a coffee shop merchant) and include a wireless network service with a coverage area 701. In one instance, the service provider may wish to limit access to the service 700 to users/customers 703 who may be located in certain areas associated with the service provider, for example, inside a target area 705 (e.g., in the coffee shop.) In one embodiment, a user device of the user 703 may detect and process a plurality of signals from at least one of the various sources 707a-707d (source 707) for determining one or more information items (e.g., access code seed.) For example, at least one source 707 may provide one or more audio or optical signals. In one embodiment, a graphical representation of the target area 705 may be presented to a user via a UI on a UE 101. In one embodiment, a UE 101 may detect one or more audio or optical signal samples from at least one source 707 the system 100 may determine, detected by the UE 101 in an audio or optical signal sample from at least one source 707 and provided by the user device, if a user 709 is in or outside of the target area 703, wherein if the signal sample does not substantially match to that the access point of the service 700 is expecting, the user may be presented with a notification that the service 700 may be discontinued if the user is not able to detect and provide a correct signal sample. For example, the user may be in an area 711 where he may be prompted to move back into the area 705 or move closer to at least one of the signal sources 707a-707d in order to capture a signal sample. In one embodiment, if the user 713 may be outside of the target area 703 and 711 (e.g., but still within the coverage area 701), then access codes generated based on the signals and/or access code seed may no longer be valid for accessing the service 700 and it may be terminated.

The processes described herein for a mechanism to generating access codes based on information embedded in various signals may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

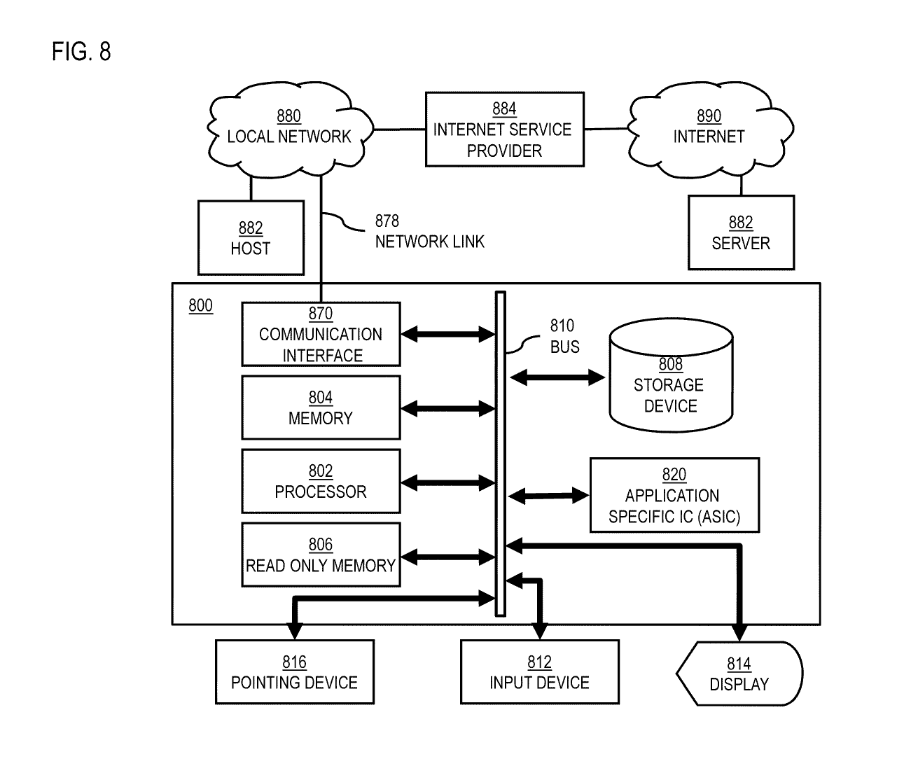

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to generating access codes based on information embedded in various signals as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of generating access codes based on information embedded in various signals.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to generating access codes based on information embedded in various signals. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for generating access codes based on information embedded in various signals. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for generating access codes based on information embedded in various signals, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814, and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic, or electromagnetic signals, including infrared and optical signals that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 111 for generating access codes based on information embedded in various signals.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880, and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

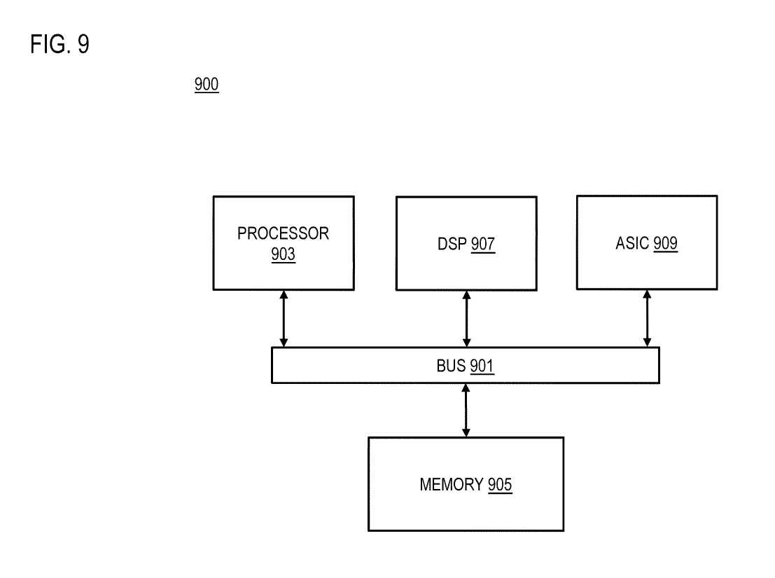

FIG. 9 illustrates a chip set or chip 900 upon which an embodiment of the invention may be implemented. Chip set 900 is programmed generating access codes based on information embedded in various signals as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of generating access codes based on information embedded in various signals.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to generating access codes based on information embedded in various signals. The memory 905 also stores the data associated with or generated by the execution of the inventive steps.

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of generating access codes based on information embedded in various signals. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of generating access codes based on information embedded in various signals. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 for generating access codes based on information embedded in various signals. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

Additionally, sensors module 1053 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1001 (e.g., a mobile phone), a user of the mobile terminal 1001, an environment of the mobile terminal 1001 and/or the user, or a combination thereof, wherein the data may be collected, processed, stored, and/or shared with one or more components and/or modules of the mobile terminal 1001 and/or with one or more entities external to the mobile terminal 1001.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
an acquisition of one or more signals broadcasted within an environment;
a processing of the one or more signals to determine at least one access code seed associated with one or more location-based services available in the environment; and
a generation of at least one access code for accessing the one or more location-based services based, at least in part, on the at least one access code seed.

2. A method of claim 1, wherein the (1) data and/or (2) information and/or (3) at least one signal are further based, at least in part, on the following:
a transmission of the at least one access code to an access point client for accessing at least one of the one or more location-based services,
wherein the at least one of the one or more location-based services is a wireless communication network service.

3. A method of claim 2, wherein the (1) data and/or (2) information and/or (3) at least one signal are further based, at least in part, on the following:
at least one determination of one or more location characteristics of a user device with reference to a point of interest associated with the environment; and
a transmission of the one or more location characteristics to the access point client for accessing at least one of the one or more location-based services.

4. A method of claim 1, wherein the one or more signals include an audio signal, an optical signal, or a combination thereof.

5. A method of claim 1, wherein the (1) data and/or (2) information and/or (3) at least one signal are further based, at least in part, on the following:
at least one determination of a change in the at least one access code seed; and
an update to the at least one access code based, at least in part, on the change in the at least one access code seed.

6. A method of claim 1, wherein the generation of the at least one access code is based, at least in part, on one or more information items associated with a user, a user device, or a combination thereof.

7. A method of claim 1, wherein the (1) data and/or (2) information and/or (3) at least one signal are further based, at least in part, on the following:
a termination of an access to at least one of the one or more location-based services based, at least in part, on a discontinued acquisition of the one or more signals.

8. A method of claim 1, wherein the (1) data and/or (2) information and/or (3) at least one signal are further based, at least in part, on the following:
at least one determination of one or more information items associated with the environment, a service provider associated with the environment, or a combination thereof for decrypting at least one encrypted access code seed.

9. A method of claim 8, wherein the (1) data and/or (2) information and/or (3) at least one signal are further based, at least in part, on the following:
an initiation of the processing of the one or more signals based, at least in part, on a transaction with a device associated with the service provider, a capture, at the user device, of a media item associated with the environment, or a combination thereof.

10. A method of claim 9, wherein the initiation is based, at least in part, on one or more trigger signals in the one or more signals.

11. An apparatus comprising:
at least one processor; and
at least one memory including computer program code for one or more programs,
the at least one memory and the computer program code configured to, with the at least one processor, cause the apparatus to perform at least the following,
cause, at least in part, an acquisition of one or more signals broadcasted within an environment;
process and/or facilitate a processing of the one or more signals to determine at least one access code seed associated with one or more location-based services available in the environment; and
cause, at least in part, a generation of at least one access code for accessing the one or more location-based services based, at least in part, on the at least one access code seed.

12. An apparatus of claim 11, wherein the apparatus is further caused to:
cause, at least in part, a transmission of the at least one access code to an access point client for accessing at least one of the one or more location-based services,
wherein the at least one of the one or more location-based services is a wireless communication network service.

13. An apparatus of claim 12, wherein the apparatus is further caused to:
determine one or more location characteristics of a user device with reference to a point of interest associated with the environment; and
cause, at least in part, a transmission of the one or more location characteristics to the access point client for accessing at least one of the one or more location-based services.

14. An apparatus of claim 11, wherein the one or more signals include an audio signal, an optical signal, or a combination thereof.

15. An apparatus of claim 11, wherein the apparatus is further caused to:
determine a change in the at least one access code seed; and
cause, at least in part, an update to the at least one access code based, at least in part, on the change in the at least one access code seed.

16. An apparatus of claim 11, wherein the generation of the at least one access code is based, at least in part, on one or more information items associated with a user, a user device, or a combination thereof.

17. An apparatus of claim 11, wherein the apparatus is further caused to:
cause, at least in part, a termination of an access to at least one of the one or more location-based services based, at least in part, on a discontinued acquisition of the one or more signals.

18. An apparatus of claim 11, wherein the apparatus is further caused to:
determine one or more information items associated with the environment, a service provider associated with the environment, or a combination thereof for decrypting at least one encrypted access code seed.

19. An apparatus of claim 18, wherein the apparatus is further caused to:
cause, at least in part, an initiation of the processing of the one or more signals based, at least in part, on a transaction with a device associated with the service provider, a capture, at the user device, of a media item associated with the environment, or a combination thereof.

20. An apparatus of claim 19, wherein the initiation is based, at least in part, on one or more trigger signals in the one or more signals.

21.-48. (canceled)
